(19) United States
(12) Patent Application Publication
(10) Pub. No.: US 2015/0193229 A1
(43) Pub. Date: Jul. 9, 2015

(54) EFFICIENT PROPAGATION OF SOFTWARE BASED ON SNAPSHOT TECHNOLOGIES ENABLING MORE EFFICIENT INFORMAL SOFTWARE BUILDS

(71) Applicant: CommVault Systems, Inc., Oceanport, NJ (US)

(72) Inventor: Ketan Bansod, South Amboy, NJ (US)

(73) Assignee: COMMVAULT SYSTEMS, INC., Oceanport, NJ (US)

(21) Appl. No.: 14/148,016

(22) Filed: Jan. 6, 2014

(51) Int. Cl. G06F 9/44

(52) U.S. Cl. CPC G06F 8/71

(57) ABSTRACT

Systems and methods are disclosed that substantially overcome the long delays and unproductive cycle time inherent in managing an informal (friendly) build platform. The systems and methods disclosed herein ensure that an official software base residing on a production machine propagates efficiently to the machine that generates the friendly builds, and furthermore, the friendly-build machine experiences minimal unproductive cycle time between successive friendly builds. Accordingly, developers experience improved access to, and more efficient use of, the computing device that generates the friendly executables.

### CROSS-REFERENCE TO RELATED APPLICATION(S)

Any and all applications, if any, for which a foreign or domestic priority claim is identified in the Application Data Sheet of the present application are hereby incorporated by reference under 37 C.F.R. §1.57.

### BACKGROUND

Software development environments are typically equipped and configured to support both (i) a production (or “official”) platform, and also (ii) an informal (or “friendly”) one. Typically, the production platform comprises an official software base (e.g., source code, files, etc.) for building executable code and/or associated binary files (the “executable”). The executable(s) is/are to be shipped (and/or transmitted, installed, conveyed, etc.) to customers as an “official release.” In the course of preparing the official release, the production platform comprises an official software base that is under development. During the course of the development cycle of the official release, the official software base residing on the production platform is updated whenever a new feature is deemed of good enough quality to be incorporated, evolving gradually until the official software base is complete and ready to be built into an official release to customers.

The friendly platform, on the other hand, typically generates executables based on informal (friendly) changes to the official software base. The friendly executable(s) are needed for informal uses. Examples of informal uses include testing and experimentation by members of the development team, deploying informal diagnostic code to a test team or customer site, conducting beta tests at one or more customer sites, etc. In general, friendly builds are more numerous and more frequent than official builds, because typically there are far more developers seeking to test out features under development than there are official releases built for external release. A typical prior-art approach to operating the production and friendly platforms in a software development environment is illustrated in FIG. 1, with additional detail provided in FIGS. 2A and 2B. As will be explained in more detail in regard to these figures, the prior art approaches have disadvantages that make them unsuitable for large software development platforms with a large software base and many developers vying for friendly builds.

FIG. 1 depicts a typical prior-art approach to operating a production platform and a friendly build platform in a prior-art software development environment. FIG. 1 depicts computing device C (element 110), computing device F (element 120), computing device D (element 130), and users and/or customers 101, which are interconnected and communicatively coupled as shown.

Computing device C is a production machine, which is part of a production platform, and comprises: an official software base 102 (e.g., source code, files, operational parameters, etc.), illustratively designated as version 1.0.0; and an executable official release 103, illustratively designated as version 1.0.0. Official release 103 is built and/or compiled from official software base 102. Official release 103 is shipped (and/or transmitted, installed, conveyed, etc.) to users/customers 101.

Computing device D is illustratively a developer's machine. The developer may use this machine to develop and/or transfer informal, experimental, and/or diagnostic changes and/or features, i.e., “friendly changes” 111. The developer may further use computing device D to execute, test, and try out a “friendly executable” 124 received from computing device F. Friendly executable 124 comprises the friendly changes to the official release, for example designated version 1.0.1. Optionally, friendly executable 124 may be shipped (and/or transmitted, installed, conveyed, etc.) to customers 101 as a “friendly release” for testing and/or diagnostic purposes, as shown by the dotted communication path.

Computing device F is a machine for building informal (friendly) releases as part of a friendly build platform. Computing device F receives official software base 102 and friendly changes 111 and incorporates the friendly changes into the software base as shown in block 116. This step ensures that the friendly changes are worked into a current official version of the software base. Computing device F compiles and/or builds a “friendly release” (or “friendly executable” or “friendly build”) 118 that incorporates the friendly changes submitted by the developer, and is designated version 1.0.1. The friendly executable 118 is then transmitted to computing device D and is available for the developer's further use at block 124.

FIG. 2A depicts additional details of the typical prior-art approach illustrated in FIG. 1, with particular attention to the transfer of the official software base from computing device C to computing device F. A build cycle for a friendly build is illustrated in the present figure.

Block 102 represents the current official software base on computing device C. This is the production software base that is illustratively designated version 1.0.0.

Block 204, which follows block 102, represents a copy of the official software base. For example, the copy is generated by computing device C by mirroring software base 102 to another volume. Software base copy 204 is of the same version as the official software base 102, illustratively version 1.0.0.

Each arrow 205 indicates a transfer of software base copy 204 from computing device C to computing device F. According to this typical prior-art approach to making friendly builds, this transfer is needed for EVERY build performed by computing device F. This approach proves to be a major drawback, because the transfer of a very large software base from one computing device to another can take up a substantial amount of time, possibly as long as several hours. The approach is sequential, with one transfer at a time for one build at a time on computing device F (see block 226 below), and moreover, for a software base that approximates 150 GB in size, the transfer time is several hours in duration. The larger the software base, the longer the transfer 205. When the transfer 205 from the production machine (e.g., computing device C) to the friendly build machine (e.g., computing device F) takes a long time for every build on the friendly build machine, the entire process bogs down and impedes developer productivity. The overall process is described in further detail below.

At block 206, computing device F receives the software base copy 204 from computing device C, illustratively software base version 1.0.0. At block 208, computing device F is available for use to make the next friendly build.

At block 116, after block 208, computing device F incorporates friendly changes that are received from computing device D, as described above. Incorporating changes to a software base is well known in the art, and typically uses a variety of different tools to properly update the software base with the incoming changes.

At block 118, computing device F compiles and/or builds the friendly executable, e.g., version 1.0.1, as described in more detail above. This involves techniques that are well known in the art, including the use of compilers, linking tools, build tools, error checking, etc., as necessary to generate a proper executable. For example, the compilation/build time for 3 binaries may be as long as five minutes per binary, i.e., approximately 15 minutes, as an exemplary illustration. If the executable is to be built for more than one type of target, e.g., Windows x64 and Windows 32-bit, then the 15 minutes doubles to 30 minutes to compile/build the desired friendly executables. The more binaries that are to be built, i.e., the more complex the friendly changes, the longer each compile/build operation takes. The friendly executable is then transmitted to the developer's machine, computing device D, at block 220.

At block 111 on computing device D, friendly changes are made as explained in some detail above. These changes may include new features, diagnostics, bugfixes, etc. To properly test these changes, they must be merged/incorporated into a current version of the official software base.

At block 212, after block 111, computing device D reserves computing device F for a friendly build. This enables computing device F to make itself available for a friendly build. This step may be optional or automatic, but is shown here for the sake of a clearer understanding of the overall process.

At block 214, computing device D submits the friendly changes 111 to computing device F to be incorporated into the software base at block 116, as described above. By incorporating changes to a software base, the software base is changed, illustratively to version 1.0.1. The new version of the software base is then compiled and/or built at block 118, as described above, and results in a friendly executable, e.g., version 1.0.1.

At block 220, the friendly executable (version 1.0.1) is received by computing device D from computing device F.

At block 222, computing device D releases computing device F for another build. This step may be optional or automatic, but is shown here for the sake of a clearer understanding of the overall process.

At block 124 on computing device D, after block 222, the received friendly executable (version 1.0.1) is available to the developer for further use, e.g., execution, test, diagnostics, etc. Informal uses of the friendly executable were described in more detail above.

At block 226 on computing device F, after computing device F is released by from computing device D (block 222), computing device F is still populated with the friendly version of the software base, i.e., version 1.0.1. Consequently, computing device F is not properly ready for another friendly build; if that were to happen, a second round of friendly changes would be built on top of a first round of friendly changes, i.e., on top of 1.0.1, resulting in the possibility that the first set of changes “pollutes” the second set or conflicts with it. What is required for a proper friendly build is the official software base version 1.0.0. without remnants of other friendly changes. Therefore, at block 226, computing device F requests from computing device C a fresh copy of the official software base (version 1.0.0) to be transferred (205) to computing device F. This is illustrated by loop 227 followed by arrow 205.

Loop 227 illustrates a disadvantage of the present approach, which requires that a fresh copy of the official software base be transferred (205) anew from computing device C to computing device F when a new friendly build is to be started. As noted, this transfer from one machine to the other may take hours and is highly disadvantageous. After the transfer 205 occurs, the build cycle restarts at block 206.

FIG. 2B depicts additional details of the typical prior-art approach illustrated in FIG. 1, with particular attention to the need to re-compile after each friendly build to undo the friendly changes and rebuild the original official version of the software base. FIG. 2B is presented as an alternative to the approach in FIG. 2A to attempt to overcome the re-transmission disadvantage thereof. However, it will be shown that this alternative approach presents substantial disadvantages of its own. A build cycle for a friendly build is illustrated in the present figure. Elements 102, 111, 116, 118, 124, 204, 205, 206, 208, 212, 214, and 220 were described in regard to FIG. 2A and remain substantially unchanged here.

At block 223, which occurs after the friendly executable (version 1.0.1) is received by computing device D from computing device F, computing device D is responsible for reversing (or rolling back) the friendly changes 111. Thus, at block 223, computing device D submits changes to remove friendly changes 111 from the modified software base version 1.0.1. Then computing device D releases computing device F for another friendly build.

At block 228 the software base on computing device F must be recompiled and/or rebuilt anew to remove (or roll back) the friendly changes 111 and obtain the original version (the official version) of the software base, e.g., version 1.0.0. Continuing the example described in regard to block 118 above, the time required for a friendly build of 3 binaries approximates 15 minutes, which is doubled to 30 minutes for two distinct targets (e.g., Windows x64 and Windows 32-bit). Consequently, to roll back the friendly changes via a second compile/build will take just as long as compiling/building the initial friendly executables at block 118, i.e., 30 minutes for two distinct targets. Notably, this is less time than a fresh new multi-hour transfer of the software base (transfer 205). The combination of the friendly build (118) and the rollback re-compile (228) can take 60 minutes according to the present example. Thus, the rollback re-compile doubles the cycle time of a friendly build (though it is shorter than a fresh transfer of the software base). Since the entire process is sequential, five different sets of friendly changes like this one would take five time 60 minutes, i.e., five hours. In a development environment with many developers, these kinds of time are unacceptably slow and inefficient.

After the compile/build operation 228 is complete, computing device F is available for another friendly build, as illustrated by loop 229. The build cycle restarts at block 208 if the compile/build operation successfully re-creates the original (official) version of the software base (e.g., 1.0.0). If the compile/build operation 228 is unsuccessful, for example if errors are detected, then a copy of the official software base must be transferred anew from computing device C to computing device F (loop 230 followed by arrow 205). As noted above, this may take hours, after which the build cycle restarts at block 206.

The approach of FIG. 2B is intended to avoid the need to re-transmit for every build a fresh copy of the official software base from computing device C that is depicted in FIG. 2A. As noted, that transfer (205) can take hours for a very large software base. However, the present approach of FIG. 2B has the substantial disadvantage of needing to (i) get a developer to submit an additional set of changes that correctly remove (roll back) the friendly changes 111, and (ii) execute another compile and/or build operation, which is itself time-consuming and also prone to error. Even though the compile and/or rebuild represented by block 228 may take less time than the re-transmission operation 205, it still has the disadvantageous effect of taking cycle time away from computing device F that should be preferably used for building new friendly releases. The need exists for a more efficient and less error-prone approach.

### BRIEF DESCRIPTION OF THE DRAWINGS

FIG. 1 depicts a typical prior-art approach to operating a production platform and a friendly build platform in a prior-art software development environment.

FIG. 2A depicts additional details of the typical prior-art approach illustrated in FIG. 1.

FIG. 2B depicts additional details of the typical prior-art approach illustrated in FIG. 1, as an alternative to FIG. 2A.

FIG. 3 depicts some salient portions of a system 300 for efficient propagation of a software base, and for enabling more efficient informal/friendly software builds.

FIG. 4 depicts some salient details in the operation and configuration of system 300 of FIG. 3.

FIG. 5 depicts some salient operations of a method 500 according to an illustrative embodiment of the present invention.

### DETAILED DESCRIPTION

As amply illustrated by the prior-art approaches, the need exists for a more efficient approach to managing informal (friendly) builds. Systems and methods are disclosed that substantially overcome the long delays and unproductive cycle times inherent in managing friendly builds. The systems and methods disclosed herein ensure that an official software base residing on a production machine propagates efficiently to the machine that generates the friendly builds, and furthermore, the friendly-build machine experiences minimal unproductive cycle time between successive friendly builds. Accordingly, developers experience improved access to, and more efficient use of, the computing device that generates the friendly executables. By improving the friendly build process, the entire development organization gains substantial productivity.

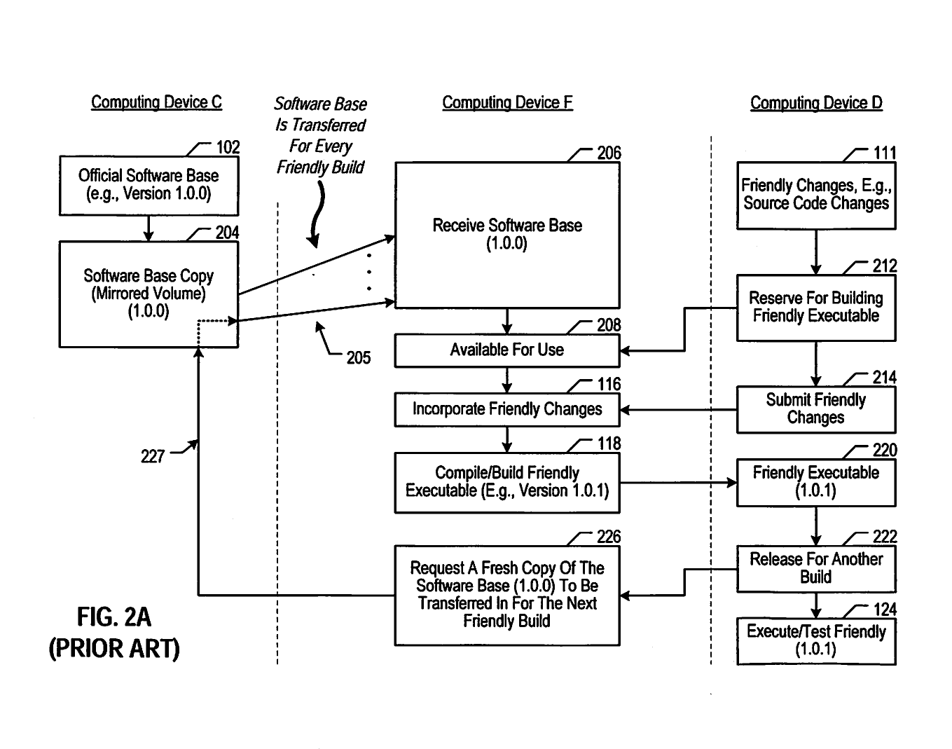

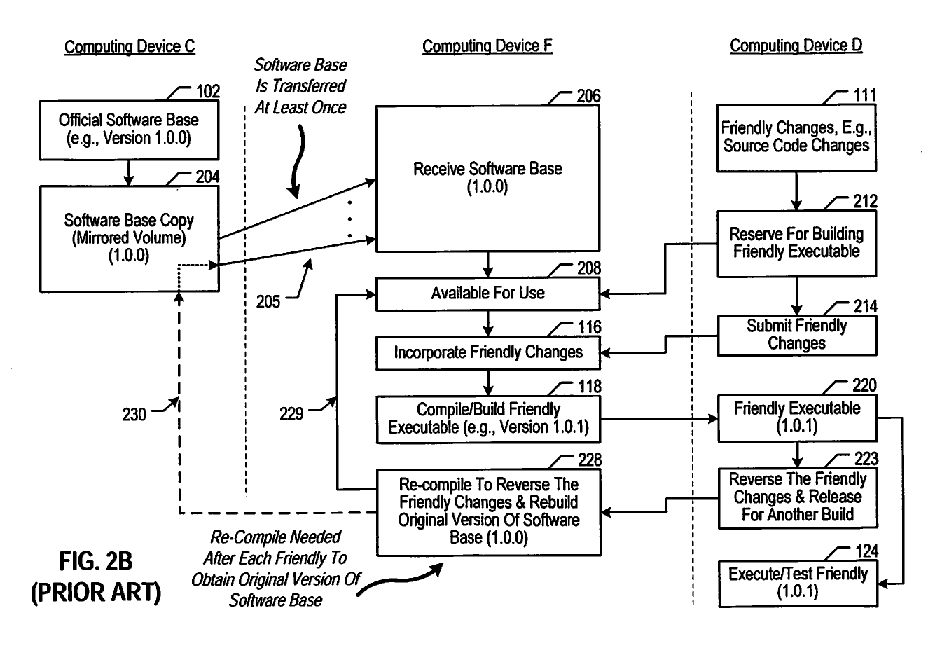

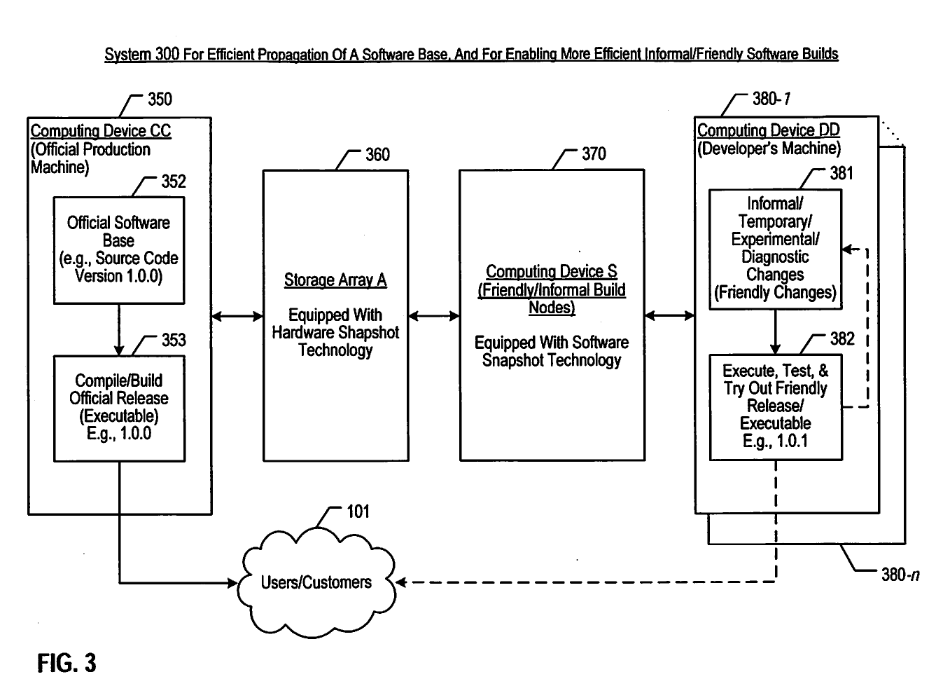

In the example set forth in regard to FIG. 2B, a friendly release comprising changes to three binaries targeted for two different execution platforms took at least 60 minutes to complete according to the prior art (see above discussion of block 228). In a contrasting example, according to the illustrative embodiment as will be shown below, a corresponding executable build takes only 15 minutes to complete—for any number of parallel builds. After a one-time propagation of the software base from the official production machine to the friendly build system 300, a friendly build's duration is no longer sequential and no longer limited by propagation time and rollback compilation time. These advantages are explained in more detail in regard to FIGS. 3, 4, and 5 below.

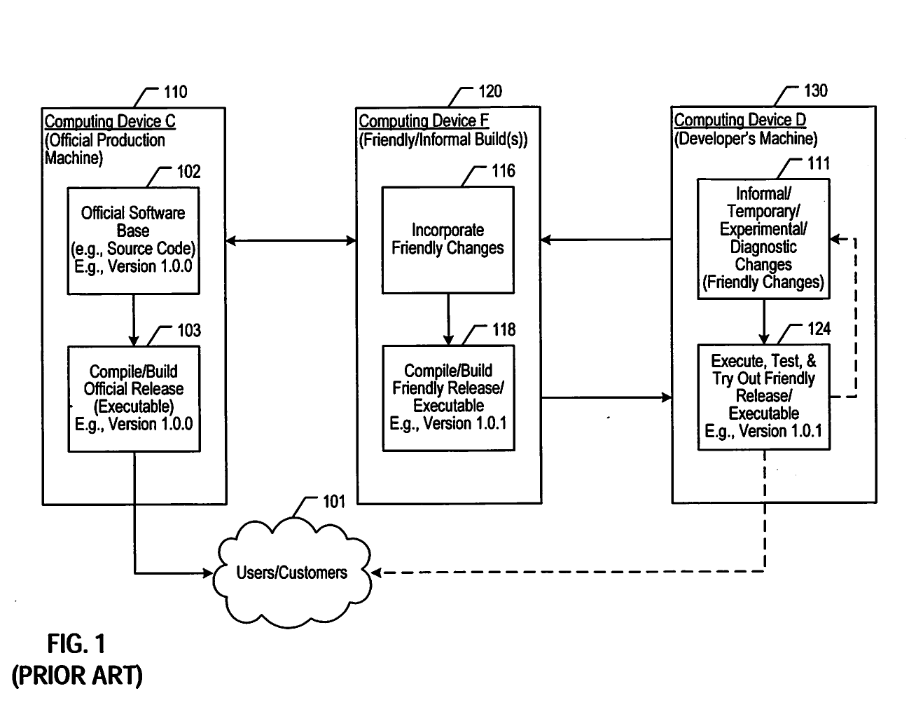

FIG. 3 depicts some salient portions of a system 300 for efficient propagation of a software base and for enabling more efficient informal/friendly software builds. System 300 comprises: storage array A (element 360) and computing device S (element 370), which are communicatively coupled to each other as well as to computing device CC (element 350) and computing device(s) DD (elements 380) as shown. Computing device CC and computing device DD are not part of system 300 according to the illustrative embodiment. In some alternative embodiments, system 300 comprises computing device CC and/or one or more computing devices DD. Users/customers 101 were described in regard to FIGS. 1, 2A, and/or 2B and remain substantially the same here. The depicted elements are communicatively coupled as shown, i.e., they communicate electronically with each other via at least a respective wired or wireless communication link according to the illustrative embodiment; they may be in direct electronic communication, e.g., via dedicated lines, or may be indirectly connected, e.g., via public and/or private telecommunications network(s) such as a local area network, a private intranet and/or the Internet, without limitation. Thus, the depicted elements are said to be communicatively coupled, though the respective communication link need not be always “on,” and may in some embodiments be an intermittent connection (e.g., on demand, scheduled, etc.).

Element 350: Computing device CC (350) is a production machine that plays a role somewhat similar to the role played by computing device C described earlier; computing device CC further comprises additional functionality (embodied in software, firmware, circuitry, connectivity, and/or configuration(s)) that enables it to properly interface with and respond to one or more components of system 300. Thus, computing device CC may comprise one or more modules (not shown) for interfacing with and responding to storage array A (360) and/or computing device S (370). For example, computing device CC may comprise a monitoring module (not shown) that keeps track of and/or reports on activity related to friendly builds on storage array A and/or computing device S. Computing device CC comprises an official software base 352 (e.g., source code, files, operational parameters, etc.), illustratively designated version 1.0.0; and an executable official release 353, illustratively designated version 1.0.0. Official release 353 is built and/or compiled from official software base 352. Official release 353 is shipped (and/or transmitted, installed, conveyed, etc.) to users/customers 101.

As used herein, the term “computing device” can include, without limitation, one or more: workstations, personal computers, desktop computers, or other types of generally fixed computing systems such as mainframe computers and minicomputers. A computing device can include mobile or portable computing devices, such as one or more laptops, tablet computers, personal data assistants, mobile phones (such as smartphones), and other mobile or portable computing devices such as embedded computers, set top boxes, vehicle-mounted devices, wearable computers, etc. Computing devices can include servers, such as mail servers, file servers, database servers, and web servers.

In some cases, a computing device includes virtualized and/or cloud computing resources. For instance, one or more virtual machines may be provided to the organization by a third-party cloud service vendor. Or, in some embodiments, computing devices can include one or more virtual machine(s) running on a physical host computing device (or “host machine”) operated by the organization. As one example, the organization may use one virtual machine as a database server and another virtual machine the official production machine described herein, both virtual machines operating on the same host machine. A virtual machine includes an operating system and associated virtual resources, and is hosted simultaneously with another operating system on a physical host computer (or host machine). A hypervisor (typically software, and also known in the art as a virtual machine monitor or a virtual machine manager or “VMM”) sits between the virtual machine and the hardware of the physical host computer. One example of hypervisor as virtualization software is ESX Server, by VMware, Inc. of Palo Alto, Calif.; other examples include Microsoft Virtual Server and Microsoft Windows Server Hyper-V, both by Microsoft Corporation of Redmond, Washington, and Sun xVM by Oracle America Inc. of Santa Clara, Calif. In some embodiments, the hypervisor may be firmware or hardware or a combination of software and/or firmware and/or hardware. The hypervisor provides to each virtual operating system virtual resources, such as a virtual processor, virtual memory, a virtual network device, and a virtual disk. Each virtual machine has one or more virtual disks. The hypervisor typically stores the data of virtual disks in files on the file system of the physical host computer, called virtual machine disk files (in the case of VMware virtual servers) or virtual hard disk image files (in the case of Microsoft virtual servers). For example, VMware's ESX Server provides the Virtual Machine File System (VMFS) for the storage of virtual machine disk files. A virtual machine reads data from and writes data to its virtual disk much the same way that an actual physical machine reads data from and writes data to an actual disk.

Element 360: Storage array A (360) is a storage device and/or system comprising a collection of storage media (preferably high availability disks) that are commonly accessible via a body of software, firmware, and/or hardware that controls and manages the collection; furthermore, according to the illustrative embodiment, storage array A is equipped with so-called hardware snapshot technology.

A snapshot is a point-in-time copy of a defined collection of data. From an end user viewpoint, a snapshot may be thought of as an instant image of data at a given point in time (e.g., a volume such as a volume comprising official software base 352). Some types of snapshots do not actually create another physical copy of all the data as it existed at the particular point in time, but may simply create pointers that are able to map files and directories to specific memory locations (e.g., to specific disk blocks) where the data resides, as it existed at the particular point in time. For example, a snapshot copy may include a set of pointers derived from the file system or an application. In some other cases, the snapshot may be created at the block level, such as where creation of the snapshot occurs without awareness of the file system. Each pointer points to a respective stored data block, so collectively, the set of pointers reflect the storage location and state of the data object (e.g., file(s) or volume(s) or data set(s)) at a particular point in time when the snapshot copy was created. In some embodiments, a snapshot may exist as a virtual file system, parallel to the actual file system. Users in some cases gain read-only access to the record of files and directories of the snapshot.

A “hardware snapshot” (or “hardware-based snapshot”) operation can be a snapshot operation where a storage device (e.g., storage array A) performs the snapshot operation in a self-contained fashion, substantially independently, using hardware, firmware and/or software residing on the storage device itself. For instance, the storage device may be capable of performing snapshot operations upon request, generally without intervention or oversight from other components of system 300. In this manner, hardware snapshots can off-load other components of system 300 from processing involved in snapshot creation and management, for example without on-going intervention from the friendly build machine computing device S, or for that matter, without on-going intervention from production build machine computing device CC. The advantageous uses and configurations of hardware snapshots in the illustrative embodiment are described in further detail in reference to other figures below.

Element 370: Computing device S (370) is a machine for building informal or friendly releases (or builds) as part of a friendly build platform. Computing device S is preferably a computing device that comprises a plurality of processor cores, i.e., a multi-core machine, where each core is an independent actual central processing unit that can read and execute program instructions. In some alternative embodiments, computing device S may be a single-core computing device or a computing device with multiple, separate processors. In the preferred multi-core configuration, computing device S may support a plurality of so-called “build-nodes,” each build-node logically comprising at least one of the plurality of processor cores in computing device S (or a separate processor in a system with multiple, single-core processors). Each build-node may support a build cycle substantially independently of the other build-nodes operating on computing device S. Furthermore, according to the illustrative embodiment, computing device S is equipped with so-called software snapshot technology.

A “software snapshot” (or “software-based snapshot”) operation can be a snapshot operation in which one or more other components in the system (e.g., a given build-node on computing device S) implement a software layer that manages the snapshot operation via interaction with local storage on or closely associated with the system, e.g., local to computing device S. For instance, the component implementing the snapshot management software layer (e.g., the given build-node on computing device S) may derive a set of pointers and/or data that represents the snapshot. The snapshot management software layer may then transmit the same to local storage, along with appropriate instructions for writing the snapshot. A software snapshot is essentially an instantaneous set of pointers to the original data (sometimes referred to as a logical view) as it was at a given point-in-time. The advantageous uses and configurations of software snapshots in the illustrative embodiment are described in further detail in reference to other figures below.

Further, computing device S (370) compiles and/or builds a plurality of informal “friendly releases” (or “friendly executables”) each of which incorporates a distinct set of friendly changes (e.g., 381) submitted from one or more computing devices DD, respectively—such that each friendly executable is built by a different build-node operating on computing device S. An illustrative friendly executable generated by a given build-node on computing device S is designated version 1.0.1, and is transmitted to the respective computing device DD to be made available for the developer's further use at block 382. The operation of system 300 and components 360 and 370 shall be described in further detail in reference to other figures below.

Elements 380: Computing device(s) DD (e.g., 380-1, . . . 380-n) are illustratively one or more developers' machine(s) that play a role in many ways similar to the role played by computing device D described earlier; each computing device DD further comprises additional functionality (embodied in software, firmware, circuitry, connectivity, and/or configuration(s)) that enables it to properly interface with and respond to one or more components of system 300, e.g., for interworking with build-nodes on computing device S. For example, a computing device DD may comprise a software module (not shown) that enables a developer to reserve one or more build-node(s) on computing device S.

A given developer may use a given computing device DD to develop (and/or transfer to the friendly build platform) informal, temporary, experimental, and/or diagnostic changes and/or features, i.e., “friendly changes” 381. The developer may further use computing device DD to execute, test, and try out a “friendly executable” received from computing device F, as shown at block 382. Friendly executable 382 comprises the friendly changes made to the official release and compiled on a given build-node on computing device S, illustratively designated version 1.0.1. Optionally, friendly executable 382 may be shipped (and/or transmitted, installed, conveyed, etc.) to users/customers 101 as a “friendly release” for testing and/or diagnostic purposes, as shown by the dotted communication path. Further friendly changes may be required after the friendly executable is tried out, as shown by the dashed loop from block 382 to block 381.

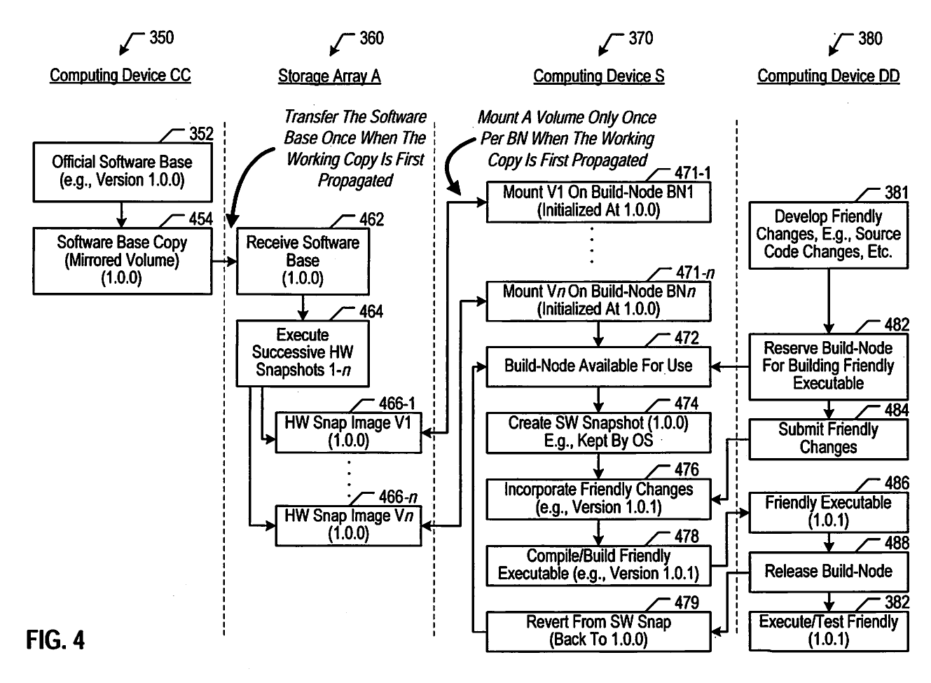

FIG. 4 depicts some salient details in the operation and configuration of system 300 of FIG. 3. As will be shown, according to the illustrative embodiment, the software base is more efficiently propagated and the friendly builds become more efficient, thus saving substantial amounts of time. Some advantages of system 300 according to the illustrative embodiment are that:

1. system 300 requires only one incoming transfer of the software base when a working copy of the official software base is first propagated, i.e., only one transfer (454-462) from the production machine computing device CC to the storage array A component of system 300; and

2. system 300 requires only one initial mounting of a given hardware snapshot volume (on storage array A at 471) to a corresponding build-node (on friendly build machine computing device S) when the working copy of the software base is first propagated to system 300; and

3. system 300 requires no recompiling operations to re-build (or roll back to) the original version of the software base before a new friendly build cycle may begin.

These advantages provide substantial operational gains in the illustrative development environment as compared to the prior art of FIGS. 1, 2A, and 2B. The gains according to the illustrative embodiment may best be measured in terms of time saved by substantially reducing the amount of time required to propagate the working version of the software base to the friendly build system 300 and further by substantially reducing the delay between friendly builds. As a result of these gains, developers may have substantially more cycle time available on a friendly build platform, no matter the size of the official software base or the number/extent/complexity of changes implemented in any given friendly build. These gains enable far more efficiency in generating and managing informal/friendly software builds than any system/method available in the prior art.

First, system 300 eliminates the need to transfer a given version of the official software base more than once to the friendly build platform, in contrast to the repeated data transfers necessitated by the prior art, as illustrated by loops 227/205 and 230/205. This advantage is made possible in part by the hardware snapshot technology equipped into storage array A. Mounting a build-node to a volume comprising a hardware snapshot image of the software base could take approximately 15 minutes, in contrast to a multi-hour transfer from the production machine. This advantage is further multiplied when the friendly build machine computing device S is a multi-processor-core computing device that supports a plurality of build-nodes; in contrast, under a prior-art approach, each and every build-node would necessitate its own set of repeated data transfers illustrated by loops 227/205 and 230/205.

Second, system 300 eliminates the need to transfer the software base at all to computing device S and instead requires that a given hardware snapshot image on storage array A be mounted only once to a corresponding build node operating on computing device S—after the working copy of the official software base has been propagated from computing device CC to the storage array A. Thus, the official version of the software base (e.g., version 1.0.0) is efficiently propagated to every build-node in system 300 operating on computing device S. This advantage is made possible in part by the hardware snapshot technology equipped with storage array A, which enables the mounting of the storage array snapshot volumes. Moreover, a volume need not be mounted again, which could take approximately 15 minutes, because of the software snapshot technology equipped into the friendly build machine computing device S. This advantage is further multiplied when the friendly build machine computing device S is a multi-processor-core computing device that supports a plurality of build-nodes; in contrast, under a prior-art approach, each and every build-node would necessitate its own set of repeated data transfers illustrated by loops 227/205 and 230/205.

Third, system 300 requires no recompiling operations to re-build the official version of the software base in preparation for a new friendly build cycle. After a friendly build is completed by a given build-node, the build-node need not re-compile (roll back changes) to re-build the original version of the software base, in contrast to operation 228 necessitated by the prior art. Instead, the given build-node reverts to the official version of the software base from a locally-available software snapshot—an operation having a duration that is virtually negligible. Moreover, any developer errors that might have been introduced to remove the friendly changes and enable the original software version to be re-built are now eliminated, as are any errors in the compilation process. Additionally, the use of the software snapshot also eliminates the need to re-mount a volume on storage array A, thus saving approximately 15 minutes in the cycle time needed for a friendly build. Thus, a process that in the prior art could take five hours for five distinct sets of friendly changes may take as little as 15 minutes according to the illustrative embodiment, which makes both propagation of the software base and the build cycle itself more efficient and less prone to developer error. Further details of the operation of system 300 are given below.

Official software base 352 on computing device CC was described in the preceding figure. This is the production software base (illustratively version 1.0.0) into which friendly changes are to be incorporated to generate friendly builds.

Software base copy 454 is a “working copy” of the official software base. Typically, the working copy 454 is maintained via a mirrored volume on or associated with computing device CC. Volume mirroring is well known in the art. This working copy of the official software base is to be propagated to the friendly build platform that comprises system 300. According to the illustrative embodiment, the working copy of the official software base (version 1.0.0) is transferred to system 300 when it is transmitted from computing device CC to storage array A.

At block 462, storage array A receives the transfer of the software base, i.e., a first version of the software base that is illustratively designated version 1.0.0. This is the first step in the propagation of the software base to system 300. The received software base is stored in a first computer-memory volume in storage array A.

At block 464, storage array A performs successive hardware snapshot operations. The number of hardware snapshots generated corresponds to the number of build-nodes on the friendly build machine computing device S. For example, if computing device S is configured with a dozen build-nodes, then likewise, storage array A is configured to execute a dozen successive hardware snapshots 1-12. The successive hardware snapshots executed at block 464 are stored in several computer-memory volumes V1-Vn, respectively, designated here as 466-1 through 466-n. In the present example, one dozen volumes designated V1-V12 are stored on storage array A. Each hardware snapshot image is of the same first version of the software base that initially was received by storage array A, illustratively every volume V1-V12 comprises software base version 1.0.0.

Blocks 471: Computing device S is illustratively configured with a plurality of build-nodes BN1-BNn, each build-node comprising at least one processor-core on computing device S. At blocks 471, each build node BNn mounts a corresponding volume Vn on storage array A. Thus, each volume Vn on storage array A is mounted to a corresponding build-node BNn on computing device S. For example, build-node BN1 mounts volume V1, and correspondingly volume V1 is said to be mounted to build-node BN1. The effect of mounting a volume on a build-node, according to the illustrative embodiment, is that the build-node is thereby initialized to the version of the software base that the volume comprises. Illustratively, the build-node is initialized to the first version of the software base that was captured in the hardware snapshots, e.g., software base version 1.0.0.

At block 472, the respective build-node on computing device S, illustratively build-node BNn, is available for use to generate a friendly build. At this stage, build-node BNn has been initialized in an earlier operation to the first version of the software base, e.g., software base version 1.0.0., and may be reserved for use by a computing device DD, illustratively from block 482.

At block 474, build-node BNn creates a software snapshot of the initialized software base, illustratively software base version 1.0.0. As noted earlier, software snapshots are created and maintained locally on computing device S, illustratively by the respective build-node BNn. In some embodiments, a centralized software snapshot utility may operate on computing device S. In some embodiments the operating system of each build-node creates and maintains the software snapshots. In some other embodiments, another software utility managed by the operating system of computing device S creates and maintains the software snapshots. The respective software snapshot is maintained in a persistent state such that the build-node may revert from the software snapshot at a later time, as explained in further detail below.

At block 476, build-node BNn incorporates friendly changes into the software base, as received from block 484 on computing device DD. This operation may require one or more submission tools and/or configuration and/or build tools necessary to complete the submit operation from computing device DD to the targeted build-node and to properly incorporate the submitted changes. These kinds of tools are well known in the art. Any number and extent of friendly changes, having any degree of complexity, may be incorporated here. For example, the friendly changes may comprise one or more: diagnostic changes that generate reports and/or events, changes to existing features, bugfixes, new features and/or capabilities, etc., without limitation. By incorporating the friendly changes into the software base, the software base on the build-node is no longer identical to the initialized first version, and instead is of a different version, illustratively version 1.0.1. Notably, no formal versioning system or nomenclature is required here. Rather, the present block illustrates the fact that the first version of the software base, illustratively designated 1.0.0, has morphed to a different second version of the software base after the friendly changes have been incorporated, illustratively designated version 1.0.1 to distinguish the second version from the first.

At block 478, build-node BNn on computing device S compiles (or builds) a “friendly executable” that is based on the second version of the software base from the preceding block. Compilers and build tools for this operation are well known in the art. Thus, the friendly executable or friendly build is designated to have the second version number, corresponding to the second version of the software base, e.g., version 1.0.1. The friendly executable now comprises the friendly changes in executable form, e.g., working diagnostics, working features, etc. Once the friendly executable has been built, computing device S transmits it electronically to computing device DD, where it is received at block 486.

At block 479, build-node BNn reverts to the first version of the software base (the official version) based on the software snapshot created at block 474. Once the friendly executable has been built and transmitted to computing device DD at block 478, the build-node needs to make itself available for another friendly build (which shall involve a new set of friendly changes from a computing device DD). However, in the current configuration, build-node BNn is populated with the second version of the software base (e.g., friendly version 1.0.1), which comprises the first set of friendly changes 381. Adding a new set of friendly changes to this software base is undesirable and generally considered to be poor programming practice, because friendly changes would be added to a “polluted” potentially buggy friendly software base rather than to the “clean” official software version. Therefore, before it can make itself available for another friendly build, build-node BNn must re-initialize to the official version of the software base, i.e., the first version of the software base illustratively version 1.0.0. Therefore, at block 479, build-node BNn on computing device S executes a “revert” operation based on the software snapshot created at block 474; this operation re-initializes the build-node to the first (official) version of the software base, illustratively version 1.0.0.

Notably, the present revert-to-software-snapshot operation is speedier than the recompile operation required in the prior-art approach at block 228 in FIG. 2B, and also speedier than a fresh transfer of the software base from a production machine as depicted by loop 227/205 in FIG. 2A. Rather, the software snapshot maintained locally by the build-node and/or computing device S is immediately available to re-initialize the build-node to the official software base (version 1.0.0). This means that virtually no computing/cycle time is wasted on the build-node before the build-node is available for a fresh friendly build as control passes back to block 472.

Block 381 on computing device DD was described in detail above. The friendly changes represented by this block may be informal, temporary, experimental, and/or diagnostic changes and/or features, without limitation.

At block 482, computing device DD optionally reserves a build-node (e.g., BNn) on computing device S. This may be an express operation invoked by the user of computing device DD. In some embodiments, this operation may be automatic, included in a workflow supporting the developer/user of computing device DD. This operation electronically transmits a message to computing device S to reserve an idle build-node (at block 472) for a friendly build associated with computing device DD.

At block 484, computing device DD submits the friendly changes (381) to the reserved build-node at block 476. This operation may require one or more submission tools and/or configuration and/or build tools necessary to complete the submit operation from computing device DD to the targeted build-node. These are well known in the art.

At block 486, computing device DD receives from computing device S the friendly executable built on build-node BNn. The executable represents the changed (second) version of the software that incorporates the friendly changes 381, e.g., version 1.0.1

At block 488, following the successful receipt of the friendly executable, computing device DD may release its use of the build-node on computing device S, e.g., build-node BNn. This may be an express operation invoked by the user of computing device DD. In some embodiments, this operation may be automatic, included in a workflow supporting the developer/user of computing device DD following the receipt of the friendly executable. This operation electronically transmits a message to computing device S (at block 479) to release the build-node for another friendly build.

At block 382, which was described in detail above, the friendly executable is available for the developer's use on computing device DD. This may include executing the friendly executable locally on computing device DD and/or may involve the friendly executable being transferred to another machine for execution, e.g., a test bed, a test platform, users/customers 101, etc., without limitation.

It is to be understood that the operations, connectivity, and sequence of events are presented in the present figure and in regard to system 300 as an illustrative example of an embodiment according to the present invention. Some operations and sub-operations have been simplified, omitted and/or consolidated to enhance the reader's understanding of the embodiment. For example, the functionality of the depicted computing device S and/or storage array A may be sub-divided differently, consolidated (in whole or in art), and may reside within or outside of the recited devices and/or in a distributed, virtualized, or cloud computing environment. In alternative embodiments, the flow of operations may be differently organized, executed, sequenced, sub-divided into sub-operations, consolidated, and/or distributed for execution among different components and/or computing platforms.

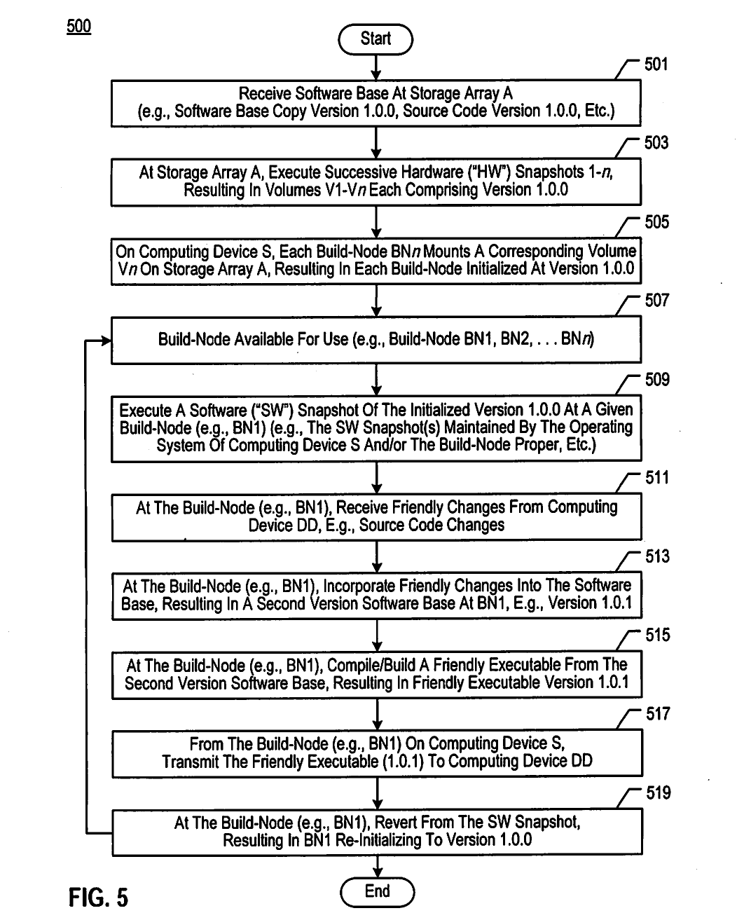

FIG. 5 depicts some salient operations of a method 500 according to an illustrative embodiment of the present invention. Illustratively, method 500 is executed collectively by the components of system 300, illustratively by storage array A and/or computing device S, as appropriate to the operation. Method 500 is described in further detail below.

At block 501, storage array A receives a software base, illustratively a working copy of the official software base; see also block 462 above. Illustratively, the received working software base is version 1.0.0. This is the first step in the propagation of the software base to system 300.

At block 503, storage array A executes successive hardware snapshots 1 through n, each hardware snapshot stored in a corresponding computer-memory volume V1 through Vn on the storage array A; see also block 464 above. Each volume comprises version 1.0.0 of the software base, which is illustratively the current official version.

At block 505, on computing device S, each build-node mounts a corresponding volume on storage array A that comprises a hardware snapshot of the official software base, thereby initializing the build-node to the official version of the software base (1.0.0). For example, build-node BN1 mounts volume V1 and becomes initialized at version 1.0.0 of the software base. This is another step in the propagation of the official version of the software base to system 300.

At block 507, having initialized to the official version of the software base (e.g., 1.0.0), the build-node is available for use to build a friendly release (or friendly executable). Notably, each build-node operates substantially independently of the other build-nodes operating on computing device S, according to the illustrative embodiment. Therefore, all build-nodes need not become available concurrently or in any particular sequence. Likewise, none of the succeeding operations associated with a given build-node need to be synchronized or coordinated with the operations of any other build-node on computing device S.

At block 507, a software snapshot operation of the initialized version of the software base is executed; see also block 474. Illustratively, this operation is performed by the operating system of the build-node, but in alternative embodiments it may be performed by the operating system of computing device S, or by another module that is operating on computing device S, whether as a centralized resource for managing software snapshots or as a build-node-specific module associated with each individual build-node on computing device S. As explained earlier, the software snapshot is maintained by the component that took the snapshot so that the build-node may revert from the software snapshot in a later operation.

At block 511, the build-node receives a set of friendly changes from computing device DD. The friendly changes may comprise changes to source code, files, liking parameters, and/or other operational parameters associated with the functionality of the software and/or associated with the build/compile rules.

At block 513, the build-node incorporates the received friendly changes into the software base, which results in a changed software base of a different (second) version; see also block 476. Illustratively, the second version of the software base is designated 1.0.1. As noted earlier, formal versioning of the software base is not required here, but the nomenclature is used herein to enhance the reader's understanding. Notably, because each build-node operates substantially independently of the other build-nodes on computing device S, each build-node is incorporating a different set of friendly changes from a different source (e.g., different computing devices DD) and therefore, the resultant second version of the software base at each respective node will be different from build-node to build-node.

At block 515, the build-node compiles and/or builds a friendly executable from the second version of the software base on the build-node; see also block 478. Illustratively the friendly executable is designated version 1.0.1, consistent with the software base version upon which it was built.

At block 517, the build-node transmits the friendly executable to another computing device for test and trial, illustratively to computing device DD that submitted the friendly changes at block 484.

At block 519, the build-node re-initializes to the initial version of the software base (official version 1.0.0) by executing a revert operation based on the software snapshot previously taken; see also block 479. Thus, the software snapshot operation that was executed at block 509 comes into play here and the build-node re-initializes to version 1.0.0 based on the software snapshot. Control passes back to block 507, wherein the build-node becomes available for use for another friendly build.

It is to be understood that the operations, transfers/transmissions, and sequence of events are presented in the present figure as an illustrative example of an embodiment according to the present invention. Some operations and sub-operations have been simplified, omitted and/or consolidated to enhance the reader's understanding of the embodiment. In alternative embodiments, method 500 may be differently organized, executed, sequenced, sub-divided into sub-operations, consolidated, and/or distributed for execution among different components of and/or computing platforms associated with system 300. Any number, variations, and arrangements of the operations, instructions, interactions, and reports described herein may be implemented in connection with system 300 within the scope of the present invention.

A system according to an illustrative embodiment of the present invention may comprise: a storage array comprising: a first computer-memory volume that comprises a first version of a software base transferred from a first computing device to the storage array to be propagated to the system from the first computing device, and a plurality of computer-memory volumes, wherein each of the plurality of volumes stores a hardware snapshot of the first computer-memory volume, and wherein each volume comprises the first version of the software base; a second computing device that: (i) is communicatively coupled to the storage array, (ii) comprises a plurality of nodes, wherein each node in the plurality of nodes logically comprises at least one processor-core on the second computing device, and wherein a corresponding volume in the plurality of volumes on the storage array is mounted to each respective node, thereby initializing the respective node to the first version of the software base, and (iii) is configured, with respect to any node in the plurality of nodes, to: execute a software snapshot of the first version of the software base initialized on the node, incorporate changes to the first version of the software base, resulting in a second version of the software base on the node, and re-initialize the node, based on the software snapshot, to the first version of the software base; and wherein only one transfer of the first version of the software base from the first computing device to the storage array is required for the first version of the software base to be propagated to the system. The illustrative system wherein, to propagate the first version of the software base from the first computing device to the system, it is sufficient for each volume on the storage array to be mounted only once to a corresponding respective node when the respective node is initialized, and further wherein subsequent re-initializations of the respective node to the first version of the software base are based on a software snapshot executed by the second computing device. The illustrative system wherein the second computing device is further configured with respect to any node on the second computing device to generate executable code based on the second version of the software base before the respective node is re-initialized to the first version of the software base. The illustrative system may further comprise: the first computing device; and a third computing device that is communicatively coupled to the second computing device, wherein the changes to the first version of the software base are received by the second computing device from the third computing device. The illustrative system wherein the software base comprises source code. The illustrative system wherein the software base comprises a database.

A method according to an illustrative embodiment of the present invention may comprise: initializing a node to a first version of a software base, based on a hardware snapshot of a first computer-memory volume comprising the first version of the software base, wherein the node logically comprises at least one processor-core on a computing device; incorporating, by the node, changes to the first version of the software base, resulting in a second version of the software base on the node instead of the initialized first version of the software base; and re-initializing the node to the first version of the software base, based on a software snapshot of the first version of the software base executed by the computing device before incorporating the changes to the first version of the software. The illustrative method wherein: (i) the hardware snapshot is stored in a second computer-memory volume on a storage array that is communicatively coupled to the computing device; (ii) the second volume is mounted to the node, thereby causing the initializing of the node to the first version of a software base; and (iii) re-initializing the node to the first version of the software base does not require re-mounting the second volume to the node. The illustrative method may further comprise: executing the hardware snapshot at the storage array after receiving the first version of the software base from a second computing device; and wherein, based on subsequent hardware snapshots executed by the storage array after the receiving of the first version of the software base, the first version of the software base is stored in additional respective computer-memory volumes on the storage array without additional receiving of the first version of the software base by the storage array from the second computing device. The illustrative method may further comprise: generating, by the node, executable code that is based on the second version of the software base; and re-initializing the node to the first version of the software base after the generating of the executable code. The illustrative method wherein, before it may generate another executable code, the node executes the re-initializing based on the software snapshot. The illustrative method wherein the software base comprises source code. The illustrative method wherein the computing device comprises a plurality of nodes that operate independently from each other, and further wherein each node in the plurality of nodes mounts a separate respective computer-memory volume on a storage array, the respective volume storing the first version of the software base based on the hardware snapshot; and further wherein each node in the plurality of nodes, independent of other nodes on the second computing device, (i) generates executable code and (ii) re-initializes to the first version of the software base based on a software snapshot executed at the respective node before the generating of the executable code.

A tangible and/or non-transitory computer-readable storage medium, according to an illustrative embodiment, whose contents cause a system comprising a first computing device to perform a method of propagating a first version of a software base to one or more elements of the system, the method comprising: initializing a node to the first version of a software base, based on a hardware snapshot of a first computer-memory volume comprising the first version of the software base, wherein the node logically comprises at least one processor-core on the first computing device in the system; incorporating, by the node, changes to the first version of the software base, resulting in a second version of the software base on the node instead of the initialized first version of the software base; and re-initializing the node to the first version of the software base, based on a software snapshot of the first version of the software base executed by the first computing device before incorporating the changes to the first version of the software. The illustrative computer-readable storage medium wherein: (i) the hardware snapshot is stored in a second computer-memory volume on a storage array that is communicatively coupled to the first computing device; (ii)the second volume is mounted to the node, thereby initializing the node to the first version of the software base; and (iii) re-initializing the node to the first version of the software base does not require re-mounting the second volume to the node. The illustrative computer-readable storage medium wherein the method further comprises: executing the hardware snapshot at a storage array after receiving the first version of the software base from a second computing device, wherein the storage array is communicatively coupled to the first computing device; and wherein, based on subsequent hardware snapshots executed by the storage array after the receiving of the first version of the software base, the first version of the software base is stored in additional respective computer-memory volumes on the storage array without additional receiving of the first version of the software base by the storage array from the second computing device. The illustrative computer-readable storage medium wherein the method further comprises: generating, by the node, executable code that is based on the second version of the software base; and re-initializing the node to the first version of the software base after the generating of the executable code. The illustrative computer-readable storage medium wherein the software base comprises source code. A tangible and/or non-transitory computer-readable storage medium, according to another illustrative embodiment, comprises contents that cause a system comprising a first computing device to perform any method recited herein.

Another method according to an illustrative embodiment of the present invention may comprise: propagating a first version of a software base from a first computing device to a system comprising a storage array and a second computing device, wherein the second computing device comprises a plurality of processor-cores, and wherein a node on the second computing device logically comprises at least one processor-core in the plurality of processor-cores, and further wherein the propagating comprises: storing the first version of the software base, by the storage array, in a first computer-memory volume on the storage array, wherein the first version of the software base is received from the first computing device; executing, by the storage array, a hardware snapshot of the first volume, wherein the hardware snapshot is stored in a second computer-memory volume on the storage array, and wherein the second volume comprises the first version of the software base; initializing, by the second computing device, the node to the first version of the software base by mounting the second volume on the node; executing, by the second computing device, a software snapshot of the first version of the software base initialized on the node; generating, by the node, executable code that is based on a second version of the software base that comprises changes to the first version of the software base; re-initializing the node to the first version of the software base by reverting from the software snapshot of the first version of the software base; and wherein the propagating of the first software version of the software base to the system requires only one mounting by the node of the second volume when the node is initialized. The illustrative method wherein the propagating of the first version of the software base from the first computing device to the second computing device requires only one receipt of the first version of the software base by the storage array from the first computing device. The illustrative method wherein the software base is source code. The illustrative method wherein the second computing device comprises a plurality of nodes that operate independently from each other, and further wherein each node in the plurality of nodes mounts a separate respective volume on the storage array, the respective volume storing the first version of the software base based on the hardware snapshot. The illustrative method wherein each node in the plurality of nodes, independent of other nodes on the second computing device, (i) generates executable code and (ii) re-initializes to the first version of the software base based on a software snapshot executed at the respective node before the generating of the executable code.

### Terminology

Elements in different Figures but sharing the same reference number generally represent the same element. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or” in reference to a list of two or more items, covers all of the following interpretations of the word: any one of the items in the list, all of the items in the list, and any combination of the items in the list. Likewise the term “and/or” in reference to a list of two or more items, covers all of the following interpretations of the word: any one of the items in the list, all of the items in the list, and any combination of the items in the list.

Depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially.

Systems and modules described herein may comprise software, firmware, hardware, or any combination(s) of software, firmware, or hardware suitable for the purposes described herein. Software and other modules may reside on servers, workstations, personal computers, computerized tablets, PDAs, and other devices suitable for the purposes described herein. Software and other modules may be accessible via local memory, via a network, via a browser, or via other means suitable for the purposes described herein. Data structures described herein may comprise computer files, variables, programming arrays, programming structures, or any electronic information storage schemes or methods, or any combinations thereof, suitable for the purposes described herein. User interface elements described herein may comprise elements from graphical user interfaces, command line interfaces, and other suitable interfaces.

Further, the processing of the various components of the illustrated systems can be distributed across multiple machines, networks, and other computing resources. In addition, two or more components of a system can be combined into fewer components. Various components of the illustrated systems can be implemented in one or more virtual machines, rather than in dedicated computer hardware systems. Likewise, the data repositories shown can represent physical and/or logical data storage, including, for example, storage area networks or other distributed storage systems. Moreover, in some embodiments the connections between the components shown represent possible paths of data flow, rather than actual connections between hardware. While some examples of possible connections are shown, any of the subset of the components shown can communicate with any other subset of components in various implementations.

Embodiments are also described above with reference to flow chart illustrations and/or block diagrams of methods, apparatus (systems) and computer program products. Each block of the flow chart illustrations and/or block diagrams, and combinations of blocks in the flow chart illustrations and/or block diagrams, may be implemented by computer program instructions. Such instructions may be provided to a processor of a general purpose computer, special purpose computer, or other programmable data processing apparatus to produce a machine, such that the instructions, which execute via the processor of the computer or other programmable data processing apparatus, create means for implementing the acts specified in the flow chart and/or block diagram block or blocks.

These computer program instructions may also be stored in a computer-readable memory that can direct a computer or other programmable data processing apparatus to operate in a particular manner, such that the instructions stored in the computer-readable memory produce an article of manufacture including instruction means which implement the acts specified in the flow chart and/or block diagram block or blocks. The computer program instructions may also be loaded onto a computer or other programmable data processing apparatus to cause a series of operations to be performed on the computer or other programmable apparatus to produce a computer implemented process such that the instructions which execute on the computer or other programmable apparatus provide steps for implementing the acts specified in the flow chart and/or block diagram block or blocks.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

To reduce the number of claims, certain aspects of the invention are presented below in certain claim forms, but the applicant contemplates the various aspects of the invention in any number of claim forms. For example, while only one aspect of the invention is recited as a means-plus-function claim under 35 U.S.0 sec. 112(f) (AIA), other aspects may likewise be embodied as a means-plus-function claim, or in other forms, such as being embodied in a computer-readable medium. Any claims intended to be treated under 35 U.S.C. §112(f) will begin with the words “means for”, but use of the term “for” in any other context is not intended to invoke treatment under 35 U.S.C. §112(f). Accordingly, the applicant reserves the right to pursue additional claims after filing this application, in either this application or in a continuing application.

I/we claim:

1. A system comprising:
a storage array comprising:
a first computer-memory volume that comprises a first version of a software base transferred from a first computing device to the storage array to be propagated to the system from the first computing device, and
a plurality of computer-memory volumes, wherein each of the plurality of volumes stores a hardware snapshot of the first computer-memory volume, and wherein each volume comprises the first version of the software base;
a second computing device that:
(i) is communicatively coupled to the storage array,
(ii) comprises a plurality of nodes, wherein each node in the plurality of nodes logically comprises at least one processor or one processor-core on the second computing device, and wherein a corresponding volume in the plurality of volumes on the storage array is mounted to each respective node, thereby initializing the respective node to the first version of the software base, and
(iii) is configured, with respect to any node in the plurality of nodes, to:
execute a software snapshot of the first version of the software base initialized on the node,
incorporate changes to the first version of the software base, resulting in a second version of the software base on the node, and
re-initialize the node, based on the software snapshot, to the first version of the software base; and
wherein only one transfer of the first version of the software base from the first computing device to the storage array is required for the first version of the software base to be propagated to the system.

2. The system of claim 1 wherein, to propagate the first version of the software base from the first computing device to the system, it is sufficient for each volume on the storage array to be mounted only once to a corresponding respective node when the respective node is initialized, and further wherein subsequent re-initializations of the respective node to the first version of the software base are based on a software snapshot executed by the second computing device.

3. The system of claim 1 wherein the second computing device is further configured with respect to any node on the second computing device to generate executable code based on the second version of the software base before the respective node is re-initialized to the first version of the software base.

4. The system of claim 1 further comprising:
the first computing device; and
a third computing device that is communicatively coupled to the second computing device, wherein the changes to the first version of the software base are received by the second computing device from the third computing device.

5. The system of claim 1 wherein the software base comprises source code or a database.

6. The system of claim 1 wherein the storage array comprises cloud-based storage, wherein at least some of the changes to the first version are received from a third computer, and wherein the third computer is wirelessly coupled to the system.

7. A method comprising:
initializing a node to a first version of a software base, based on a hardware snapshot of a first computer-memory volume comprising the first version of the software base,
wherein the node logically comprises at least one processor or one processor-core on a computing device;
incorporating, by the node, changes to the first version of the software base to produce a second version of the software base on the node instead of the initialized first version of the software base; and
re-initializing the node to the first version of the software base, based on a software snapshot of the first version of the software base executed by the computing device before incorporating the changes to the first version of the software.

8. The method of claim 7 wherein:
(i) the hardware snapshot is stored in a second computer-memory volume on a storage array that is communicatively coupled to the computing device;
(ii) the second volume is mounted to the node, thereby causing the initializing of the node to the first version of a software base; and
(iii) re-initializing the node to the first version of the software base does not require re-mounting the second volume to the node.

9. The method of claim 8 further comprising:
executing the hardware snapshot at the storage array after receiving the first version of the software base from a second computing device; and
wherein, based on subsequent hardware snapshots executed by the storage array after the receiving of the first version of the software base, the first version of the software base is stored in additional respective computer-memory volumes on the storage array without additional receiving of the first version of the software base by the storage array from the second computing device.

10. The method of claim 7 further comprising:
generating, by the node, executable code that is based on the second version of the software base; and
re-initializing the node to the first version of the software base after the generating of the executable code.

11. The method of claim 10 wherein, before it may generate another executable code, the node executes the re-initializing based on the software snapshot.

12. The method of claim 7 wherein the software base comprises source code.

13. The method of claim 7 wherein the computing device comprises a plurality of nodes that operate independently from each other, and further wherein each node in the plurality of nodes mounts a separate respective computer-memory volume on a storage array, the respective volume storing the first version of the software base based on the hardware snapshot.

14. The method of claim 12 wherein each node in the plurality of nodes, independent of other nodes on the second computing device, (i) generates executable code and (ii) re-initializes to the first version of the software base based on a software snapshot executed at the respective node before the generating of the executable code.

15. A tangible computer-readable storage medium whose contents cause a system comprising a first computing device to perform a method of propagating a first version of a software base to one or more elements of the system, the method comprising:
initializing a node to the first version of a software base, based on a hardware snapshot of a first computer-memory volume comprising the first version of the software base,
wherein the node logically comprises at least one processor or one processor-core on the first computing device in the system;
incorporating, by the node, changes to the first version of the software base, resulting in a second version of the software base on the node instead of the initialized first version of the software base; and
re-initializing the node to the first version of the software base, based on a software snapshot of the first version of the software base executed by the first computing device before incorporating the changes to the first version of the software.

16. The computer-readable storage medium of claim 15 wherein:
(i) the hardware snapshot is stored in a second computer-memory volume on a storage array that is communicatively coupled to the first computing device;
(ii) the second volume is mounted to the node, thereby initializing the node to the first version of the software base; and
(iii) re-initializing the node to the first version of the software base does not require re-mounting the second volume to the node.

17. The computer-readable storage medium of claim 15 wherein the method further comprises:
executing the hardware snapshot at a storage array after receiving the first version of the software base from a second computing device, wherein the storage array is communicatively coupled to the first computing device; and
wherein, based on subsequent hardware snapshots executed by the storage array after the receiving of the first version of the software base, the first version of the software base is stored in additional respective computer-memory volumes on the storage array without additional receiving of the first version of the software base by the storage array from the second computing device.

18. The computer-readable storage medium of claim 15 wherein the method further comprises:
generating, by the node, executable code that is based on the second version of the software base; and
re-initializing the node to the first version of the software base after the generating of the executable code.

19. The computer-readable storage medium of claim 15 wherein the software base comprises source code.
